(19) United States
(12) Patent Application Publication
(10) Pub. No.: US 2025/0210944 A1
(43) Pub. Date: Jun. 26, 2025

(54) SPARK PLUG

(71) Applicant: Niterra Co., Ltd., Nagoya-shi (JP)

(72) Inventors: Satoshi NOGUCHI, Nagoya-shi (JP); Shigehiro OHTSUKA, Nagoya-shi (JP); Katsunori HAGIWARA, Nagoya-shi (JP); Takuo NIWA, Nagoya-shi (JP); Haruki YOSHIDA, Nagoya-shi (JP); Ryota SAKAI, Nagoya-shi (JP)

(73) Assignee: Niterra Co., Ltd., Nagoya-shi (JP)

(21) Appl. No.: 18/985,153

(22) Filed: Dec. 18, 2024

(30) Foreign Application Priority Data
Dec. 25, 2023 (JP) 2023-217607
Jun. 27, 2024 (JP) 2024-104371

(51) Int. Cl. H01T 13/52; H01T 13/32; H01T 13/39

(52) U.S. Cl. CPC H01T 13/52; H01T 13/32; H01T 13/39

(57) ABSTRACT

A spark plug includes: a metal shell; a center electrode held by the metal shell in an insulated manner; a ground electrode including a first end portion and a second end portion, the ground electrode being connected to the metal shell at the first end portion and extending to the second end portion; and a chip disposed on an opposed surface, in the ground electrode, opposite to a tip end surface of the center electrode. The opposed surface includes an uneven surface including an uneven portion extending in a first direction, and, in the uneven surface, a maximum height that is a distance between a highest portion and a lowest portion is 3 μm or more.

### FIELD OF THE INVENTION

The present invention relates to a spark plug including a ground electrode including a chip.

### BACKGROUND OF THE INVENTION

A spark plug includes a ground electrode including a chip and includes a center electrode electrically insulated from the ground electrode, and a discharge occurs mainly between the chip of the ground electrode and the center electrode Japanese Unexamined Patent Application Publication No. 2019-125569.

When there is a flow in a combustion chamber, a discharge path is extended downstream due to the flow, and the discharge cannot be maintained according to circumstances.

Accordingly, the present invention has been made to solve the above problem, and it is an object of the present invention to provide a spark plug capable of facilitating maintenance of discharge.

### SUMMARY OF THE INVENTION

To achieve the object, in accordance with a first aspect, a spark plug includes: a metal shell; a center electrode held by the metal shell in an insulated manner; a ground electrode including a first end portion and a second end portion, the ground electrode being connected to the metal shell at the first end portion and extending to the second end portion; and a chip disposed on an opposed surface, in the ground electrode, opposite to a tip end surface of the center electrode. The opposed surface includes an uneven surface including an uneven portion extending in a first direction, and, in the uneven surface, a maximum height that is a distance between a highest portion and a lowest portion is 3 μm or more.

In accordance with a second aspect, in the first aspect, the first direction is a longitudinal direction of the ground electrode.

In accordance with a third aspect, in the first or second aspect, the uneven surface also includes an uneven portion extending in a second direction intersecting the first direction.

In accordance with a fourth aspect, in any one of the first to third aspects, the ground electrode includes a base material and a metal film covering the base material, a thermal conductivity of the metal film is higher than a thermal conductivity of the base material, and the uneven surface is provided in a portion, of the base material, not being covered with the metal film.

In accordance with a fifth aspect, in any one of the first to fourth aspects, the maximum height of the uneven surface is 53 μm or less.

In accordance with a sixth aspect, in any one of the first to fifth aspects, when a length of the opposed surface in a longitudinal direction of the opposed surface is trisected, and the opposed surface is divided into a first portion, a second portion, and a third portion in this order from the second end portion toward the first end portion of the ground electrode, the first portion, the second portion, and the third portion include the uneven surface, and a boundary of the uneven surface exists on the third portion.

In accordance with a seventh aspect, in any one of the first to fifth aspects, when a length of the opposed surface in a longitudinal direction of the opposed surface is bisected, and the opposed surface is divided into a fourth portion and a fifth portion in this order from the second end portion toward the first end portion of the ground electrode, the fourth portion includes the uneven surface, and a boundary of the uneven surface exists on the fourth portion.

In accordance with an eighth aspect, in any one of the first to fifth aspects, when a length of the opposed surface in a longitudinal direction of the opposed surface is trisected, and the opposed surface is divided into a first portion, a second portion, and a third portion in this order from the second end portion toward the first end portion of the ground electrode, the first portion includes the uneven surface, and a boundary of the uneven surface exists on the first portion.

In accordance with a ninth aspect, in any one of the first to eighth aspects, the uneven surface is provided only in the opposed surface.

In accordance with a tenth aspect, in any one of the first to ninth aspects, the uneven surface includes a range in which five or more recessed portions exist, and protruding portions not intersecting one another exist.

According to the present invention, the chip is disposed on the opposed surface, in the ground electrode, opposite to the tip end surface of the center electrode, and the opposed surface includes the uneven surface. The maximum height that is the distance between the highest portion and the lowest portion of the uneven surface is 3 μm or more. Even when a starting point of discharge of the ground electrode is moved downstream and is out of the chip as a discharge path is extended downstream due to a flow, such a starting point of discharge is easily formed on the uneven portion of the uneven surface, and discharge can thereby be easily maintained.

### BRIEF DESCRIPTION OF THE DRAWINGS

FIG. 1 is a half-sectional view of a spark plug according to a first embodiment.

FIG. 2 is a sectional view of a center electrode and a ground electrode.

FIG. 3 is a perspective view of the ground electrode.

FIG. 4 is a plan view of the ground electrode while the part denoted by IV in FIG. 3 is enlarged.

FIG. 5 is a sectional view of the ground electrode taken along line V-V in FIG. 4.

FIG. 6 is a perspective view of a ground electrode of a spark plug according to a second embodiment.

FIG. 7 is a plan view of the ground electrode while the part denoted by VII in FIG. 6 is enlarged.

FIG. 8 is a partial sectional view of a spark plug according to a third embodiment.

FIG. 9 is a front view of the ground electrode when viewed in a direction of arrow IX in FIG. 8.

FIG. 10 is a partial sectional view of a spark plug according to a fourth embodiment.

FIG. 11 is a partial sectional view of a spark plug according to a fifth embodiment.

### DETAILED DESCRIPTION OF THE INVENTION

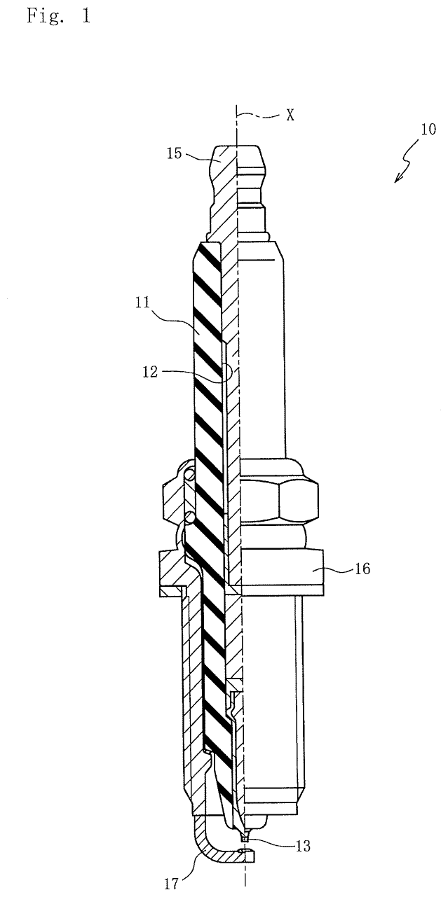

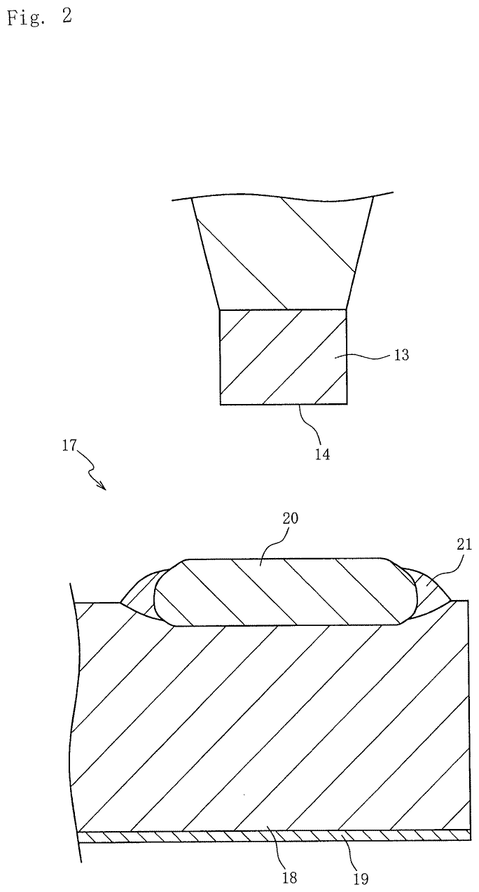

Hereinafter, preferred embodiments of the present invention will be described with reference to the accompanying drawings. FIG. 1 is a half-sectional view of a spark plug 10 according to an embodiment, with the axial line X as the boundary. The lower side on the paper sheet of FIG. 1 is referred to as the front end side of the spark plug 10, and the upper side on the paper sheet of FIG. 1 is referred to as the rear end side of the spark plug 10 (the same applies to FIGS. 2, 3, and 8 to 11).

As FIG. 1 illustrates, the spark plug 10 includes an insulator 11, a center electrode 13 held by the insulator 11, a metal shell 16 disposed on an outer periphery of the insulator 11, and a ground electrode 17 connected to the metal shell 16. The insulator 11 is a substantially cylindrical member made of ceramic, such as alumina, excellent in mechanical property and excellent in insulation performance under high temperature. The insulator 11 has an axial hole 12 along the axial line X.

The center electrode 13 is a rod-shaped conductor disposed in the axial hole 12 of the insulator 11 and extending along the axial line X. The center electrode 13 includes a core material containing copper as a main component and a bottomed cylindrical metal covering the core material. The core material may be omitted. A Ni-based alloy is given as an example of the metal constituting the center electrode 13. A tip end of the center electrode 13 projects from the insulator 11. Although a tip containing a noble metal is disposed in the tip end of the center electrode 13 in the present embodiment, the tip may be omitted.

In the axial hole 12, the center electrode 13 is electrically connected to a metal terminal 15. The metal terminal 15 is a rod-shaped member to which an ignition system (not illustrated) is connected, and the metal terminal 15 is made of a conductive metal material (such as low-carbon steel). The front end side of the metal terminal 15 is inserted into the axial hole 12, and the metal terminal 15 is fixed to the rear end side of the insulator 11 with a rear end of the metal terminal 15 projecting from the insulator 11.

The metal shell 16 is fixed to the outer periphery of the insulator 11. An external thread that is coupled with a plug hole of an engine (not illustrated) is provided for the metal shell 16. The ground electrode 17 is connected to the metal shell 16. The ground electrode 17 is a conductor extending from the metal shell 16 toward the axial line X. A core material containing copper as a main component is embedded in the ground electrode 17. The core material may be omitted.

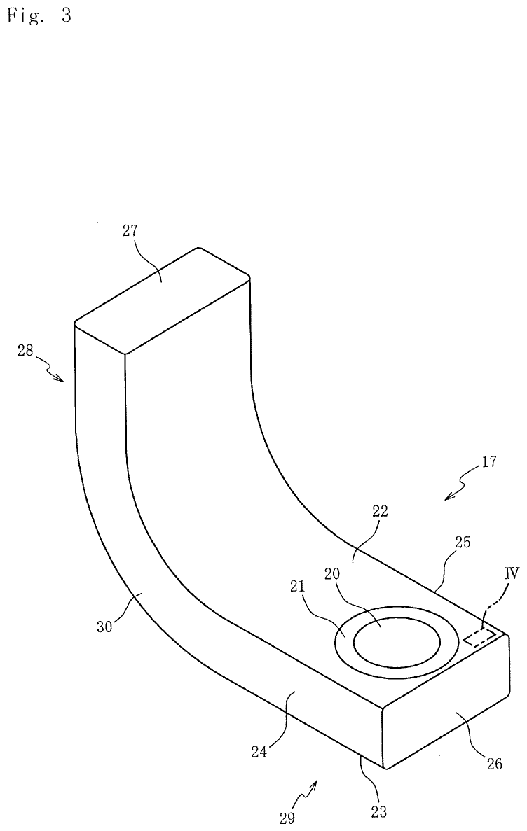

FIG. 2 is a sectional view of the center electrode 13 and the ground electrode 17. FIG. 2 illustrates a portion of the center electrode 13 and a portion of the ground electrode 17. FIG. 3 is a perspective view of the ground electrode 17. FIG. 3 illustrates a portion of the spark plug 10 without the center electrode 13, the metal shell 16, and other parts.

As FIG. 2 illustrates, the ground electrode 17 includes a base material 18 made of a metal, a chip 20 made of a metal different from the metal constituting the base material 18, a weld portion 21 joining the chip 20 to the base material 18. In the present embodiment, the base material 18 is a bent rod whose section has a quadrilateral shape, and the chip 20 has a disk shape. A part of the weld portion 21 exists between an outer periphery of the chip 20 and the base material 18.

A first element, of the elements included in the base material 18, having the highest content differs from a second element, of the elements included in the chip 20, having the highest content. The first element included in the base material 18 is, for example, Ni, and the second element included in the chip 20 is, for example, one type of noble metals such as Pt, Ir, and Ru. The weld portion 21 into which the base material 18 and the chip 20 are melted includes the first element and the second element.

As FIG. 3 illustrates, the ground electrode 17 includes an opposed surface 22 opposite to a tip end surface 14 of the center electrode 13 (refer to FIG. 2), a reverse surface 23 positioned on the reverse side of the opposed surface 22, a side surface 24 connecting the opposed surface 22 and the reverse surface 23, a side surface 25 positioned on the reverse side of the side surface 24 and connecting the opposed surface 22 and the reverse surface 23, and a distal end surface 26 connected to the opposed surface 22, the reverse surface 23, and the side surfaces 24 and 25. The opposed surface 22, the reverse surface 23, and the side surfaces 24 and 25 extend from the distal end surface 26 to an end surface 27. The end surface 27 is joined to the metal shell 16 (refer to FIG. 1).

The ground electrode 17 includes a first end portion 28 connected to the metal shell 16 (refer to FIG. 1) and having a linear shape and a second end portion 29 including the distal end surface 26 and having a linear shape. In the present embodiment, a bent portion 30 bent in a bow shape is provided between the first end portion 28 and the second end portion 29. The chip 20 is disposed, on the second end portion 29, on the opposed surface 22.

The ground electrode 17 is provided with a metal film 19 covering a portion of the base material 18 (refer to FIG. 2). A metal material constituting the metal film 19 differs from the metal material constituting the base material 18. The metal film 19 incudes at least one or more types selected from elements such as Zn, Cr, Fe, Cu, and Ag. The thermal conductivity of the metal film 19 is higher than the thermal conductivity of the base material 18. No metal film 19 is provided on the opposed surface 22. The metal film 19 is provided entirely on the side surfaces 24 and 25 and the reverse surface 23 of the ground electrode 17.

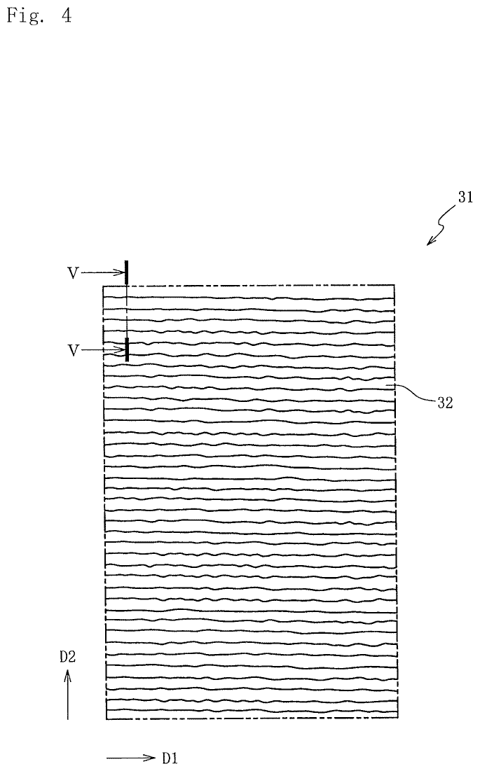

FIG. 4 is a plan view of the opposed surface 22 of the ground electrode 17 while the part denoted by IV in FIG. 3 is enlarged. The opposed surface 22 includes an uneven surface 31 including uneven portions 32. The uneven portions 32 extend in a first direction D1 and spaced in a second direction D2 orthogonal to the first direction D1. In the present embodiment, the uneven portions 32 are provided entirely in the opposed surface 22 except in spots at which the chip 20 and the weld portion 21 are provided. The first direction D1 is a longitudinal direction of the ground electrode 17, and the second direction D2 is a transverse direction of the ground electrode 17. The longitudinal direction of the ground electrode 17 is the same as a direction where a line connecting the center of the first end portion 28 and the center of the second end portion 29 along the bent portion 30 extends. The expression “the uneven portion 32 extends in the first direction D1” means that an angle of the uneven portion 32 relative to the line connecting the center of the first end portion 28 and the center of the second end portion 29 and extending along the bent portion 30 is less than 45°.

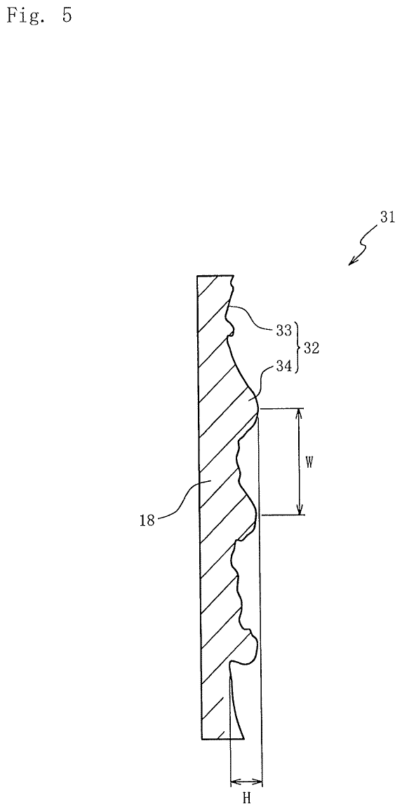

FIG. 5 is a sectional view of the ground electrode 17 (the base material 18) taken along line V-V in FIG. 4. The uneven portion 32 incudes a recessed portion 33 and a protruding portion 34 extending in the first direction D1 (the vertical direction to the paper sheet of FIG. 5), and the recessed portion 33 and the protruding portion 34 are adjacent to each other. The uneven surface 31 (refer to FIG. 4) includes a range (range IV in FIG. 3) in which five or more recessed portions 33 exist, and protruding portions 34 not intersecting one another exist.

In the uneven surface 31 (refer to FIG. 5), the maximum height that is a distance H between the highest portion (the highest protruding portion 34) and the lowest portion (the lowest recessed portion 33) of the uneven portions 32 is 3 μm or more and 53 μm or less. The maximum height is a value prescribed in JIS B 0601:2013 and is the sum of a maximum peak height value and a maximum valley depth value of the contour curve of the uneven surface 31 in a reference length (for example, 2.5 mm) in the second direction D2. The contour curve of the uneven surface 31 can be obtained by a surface roughness measuring machine. A width W between adjacent ones of the uneven portions 32 is preferably 50 μm or less.

A manufacturing method of the spark plug 10 will be described by example. First, the center electrode 13 is inserted into the axial hole 12 of the insulator 11, and the axial hole 12 is then filled up with a powder of a raw material such as conductive glass. The metal terminal 15 is inserted into the axial hole 12, and, while the insulator 11 is heated, the raw material powder is then compressed axially by using the metal terminal 15. Thus, the center electrode 13 and the metal terminal 15 are electrically connected. Next, the metal shell 16 to which the ground electrode 17 has been connected in advance is assembled to the insulator 11, and the ground electrode 17 is then bent to obtain the spark plug 10.

The ground electrode 17 is connected is subjected to a barrel plating treatment for improving mainly corrosion resistance. The metal film 19 is provided on the metal shell 16 and the ground electrode 17 by the barrel plating treatment. Before the chip 20 is welded to the opposed surface 22 of the ground electrode 17 and before the ground electrode 17 is bent, the opposed surface 22 in the form of flat surface is irradiated with a laser beam to remove the metal film 19 provided on the opposed surface 22.

For example, after the irradiation position of the laser beam is moved continuously in the first direction D1 from one end to the other end of the opposed surface 22 (from the distal end surface 26 to the end surface 27), the irradiation position of the laser beam is shifted in the second direction D2 at the end of the opposed surface 22 by an amount equivalent to a beam diameter, and such continuous movement of the irradiation position of the laser beam in the first direction D1 is again repeated to remove the metal film 19. As marks indicating the irradiation of the laser beams on the ground electrode 17, the uneven portions 32 extending in the first direction D1 are formed in a surface of the base material 18 of the opposed surface 22.

The weld portion 21 is formed, for example, by laser welding or resistance welding, on the opposed surface 22 from which the metal film 19 has been removed, and the chip 20 is joined thereto. The uneven portions 32 in the vicinity of the spot at which the chip 20 is disposed are melted into the weld portion 21, and the weld portion 21 formed in the uneven surface 31 is adjacent to the respective uneven portions 32. After the metal shell 16 is assembled to the insulator 11, the ground electrode 17 is bent to arrange the chip 20 opposite to the tip end surface 14 of the center electrode 13.

When the spark plug 10 is installed to the engine (not illustrated), the tip end surface 14 of the center electrode 13 and the ground electrode 17 are exposed in a combustion chamber. A discharge occurs between the center electrode 13 and the ground electrode 17 upon breaking of insulation between the center electrode 13 and the ground electrode 17. In the ground electrode 17, a portion at a short distance from the center electrode 13 or a protruding portion is likely to be a starting point of discharge, and a discharge path is thereby likely to be formed between the tip end surface 14 of the center electrode 13 and the chip 20.

When there is a flow in the combustion chamber, a starting point of discharge of the ground electrode 17 may be moved from the chip 20 to the vicinity of the chip 20 positioned downstream in the flow as the discharge path is extended downstream due to the flow. Since the opposed surface 22 includes the uneven surface 31 in the vicinity of the chip 20, and the maximum height of the uneven surface 31 is 3 μm or more, a starting point of discharge that is out of the chip 20 is kept on the uneven portions 32 of the uneven surface 31 and is thus hardly moved therefrom. A starting point of discharge is easily formed on the uneven portions 32, and discharge can thereby be easily maintained.

The maximum height of the uneven surface 31 is preferably 53 um or less. The reason for this is that the mechanical strength of the ground electrode 17 can be ensured because the lowest portion of the uneven portions 32 can be prevented from being a starting point of destruction of the ground electrode 17.

The flow moving from the first end portion 28 toward the second end portion 29 of the ground electrode 17 is likely to be impeded by the first end portion 28 and the bent portion 30 of the ground electrode 17, and the flow velocity of the flow thereby decreases. On the other hand, there is nothing to impede a flow moving from the side surface 24 toward the side surface 25 of the ground electrode 17, and the flow velocity of such a flow thereby hardly decreases. Thus, when there is a flow moving from the side surface 24 toward the side surface 25 of the ground electrode 17, a starting point of discharge of the ground electrode 17 is out of the chip 20 and is easily moved, on the uneven surface 31, in the transverse direction of the opposed surface 22 toward the side surface 25. Since the uneven portions 32 extend in the longitudinal direction of the ground electrode 17, a starting point of discharge is easily kept on the uneven portions 32 when moving in the transverse direction of the opposed surface 22. A starting point of discharge is easily formed on the uneven portions 32, and discharge can thereby be maintained more easily.

Since the metal film 19 is provided entirely on the side surfaces 24 and 25 and the reverse surface 23 of the ground electrode 17 and is provided continuously from the second end portion 29 to the first end portion 28 of the ground electrode 17, compared with the case where no metal film 19 is provided, the heat of the second end portion 29 heated by the discharge or by combustion of fuel is easily moved from the first end portion 28, through the metal shell 16 (refer to FIG. 1), to the engine (not illustrated) due to the heat conduction of the base material 18 and the metal film 19. The second end portion 29 is easily cooled, and overheating of the chip 20 can thereby be reduced, which can lead to improvement of the wear resistance of the chip 20.

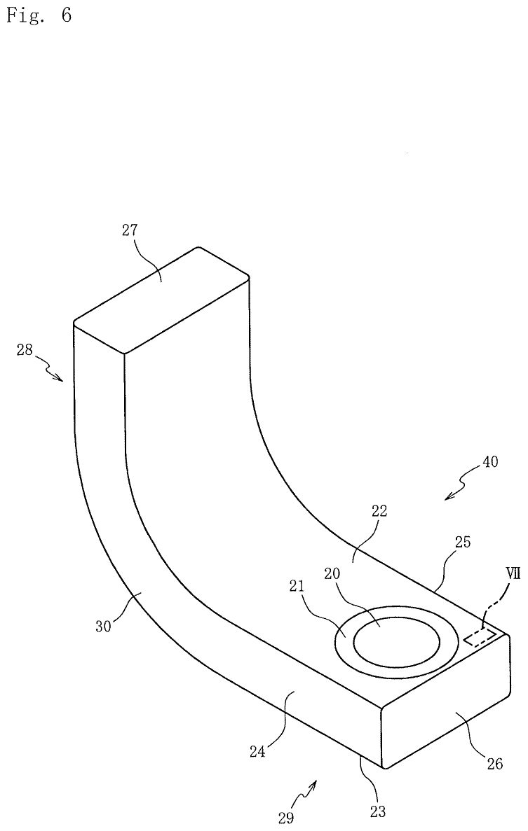

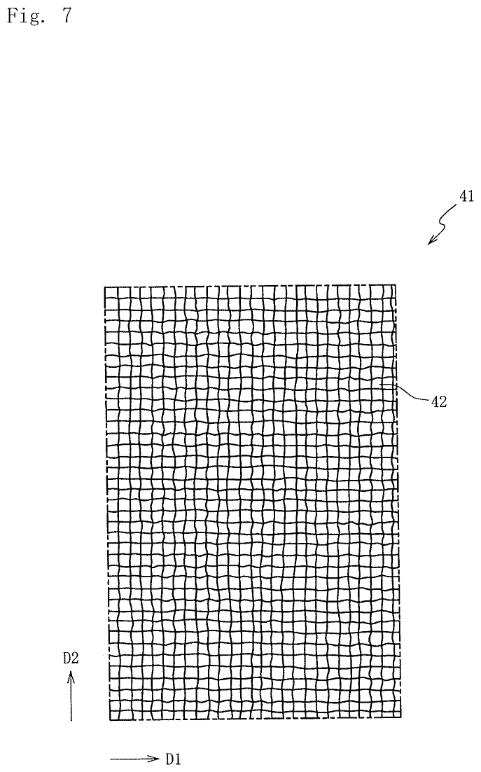

A second embodiment will be described with reference to FIGS. 6 and 7. In the first embodiment, the ground electrode 17 including the uneven surface 31 including the uneven portions 32 extending in the first direction D1 is described. In contrast, in the second embodiment, a ground electrode 40 including an uneven surface 41 including uneven portions 42 extending also in the second direction D2 intersecting the first direction D1 will be described. The same parts as those described in the first embodiment are denoted by the same reference signs, and the description thereof will hereinafter be omitted.

FIG. 6 is a perspective view of the ground electrode 40 of a spark plug 10 according to the second embodiment. The ground electrode 40 is disposed instead of the ground electrode 17 of the spark plug 10 described in the first embodiment. The ground electrode 40 is provided with a metal film 19 covering a portion of a base material 18 (refer to FIG. 2). The metal film 19 is provided entirely on a reverse surface 23 of the ground electrode 40. No metal film 19 is provided on an opposed surface 22 and side surfaces 24 and 25.

FIG. 7 is a plan view of the opposed surface 22 of the ground electrode 40 while the part denoted by VII in FIG. 6 is enlarged. The opposed surface 22 includes the uneven surface 41 including the uneven portions 42. The side surfaces 24 and 25 also each include the uneven surface 41 including the uneven portions 42. The uneven portions 42 extend in the first direction D1 and the second direction D2 orthogonal to the first direction D1. The uneven portions 42 are also marks indicating the irradiation of the laser beams on the opposed surface 22.

In the present embodiment, the uneven portions 42 are provided entirely in the opposed surface 22 and the side surfaces 24 and 25 except in spots at which a chip 20 and a weld portion 21 are provided. The expression “the uneven portions 42 extend in the first direction D1 and the second direction D2” means that an angle formed by the uneven portions 42 intersecting one another is 45° or more and 135° or less. The maximum height of the uneven surface 41 is 3 μm or more.

Since the uneven portions 42 provided in the opposed surface 22 of the ground electrode 40 extend in the longitudinal direction and the transverse direction of the ground electrode 40, even when a starting point of discharge is moved from the chip 20 to any spot on the opposed surface 22 due to a flow in the combustion chamber, such a starting point is easily kept on the uneven portions 42. A starting point of discharge is easily formed on the uneven portions 42, and discharge can thereby be maintained more easily.

Since the uneven portions 42 are also provided in the side surfaces 24 and 25 of the ground electrode 40, a discharge easily occurs also between a high portion of the uneven portions 42 in the side surfaces 24 and 25 and a center electrode 13. A starting point of discharge is easily formed on the uneven portions 42 in the side surfaces 24 and 25, and discharge can thereby be maintained more easily.

In the ground electrode 40, since the metal film 19 is provided entirely on the reverse surface 23 and is provided continuously from a second end portion 29 to a first end portion 28 of the ground electrode 40, compared with the case where no metal film 19 is provided, the second end portion 29 is easily cooled due to the heat conduction of the base material 18 and the metal film 19. Overheating of the chip 20 can be reduced, and the wear resistance of the chip 20 can thereby be improved.

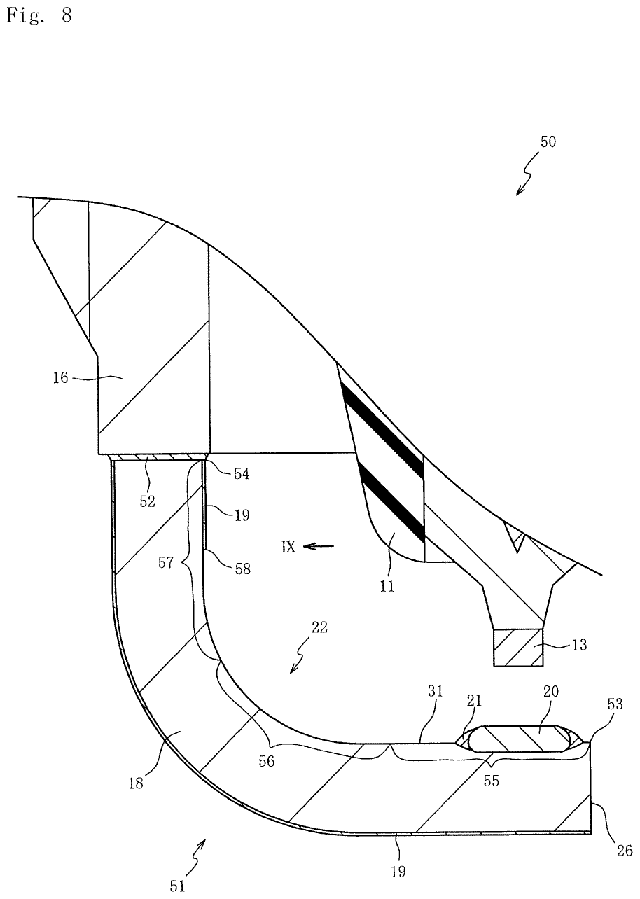

Third to fifth embodiments will be described with reference to FIGS. 8 to 11. In the first and second embodiments, the case where each of the uneven surfaces 31 and 41 is provided entirely in the opposed surface 22 of a corresponding one of the ground electrodes 17 and 40 except in the spots of the chip 20 and the weld portion 21 is described. In contrast, in the third to fifth embodiments, the case where an uneven surface 31 is provided in a portion of an opposed surface 22 will be described. In the third embodiment, the same parts as those described in the first embodiment or the second embodiment are denoted by the same reference signs, and the description thereof will hereinafter be omitted.

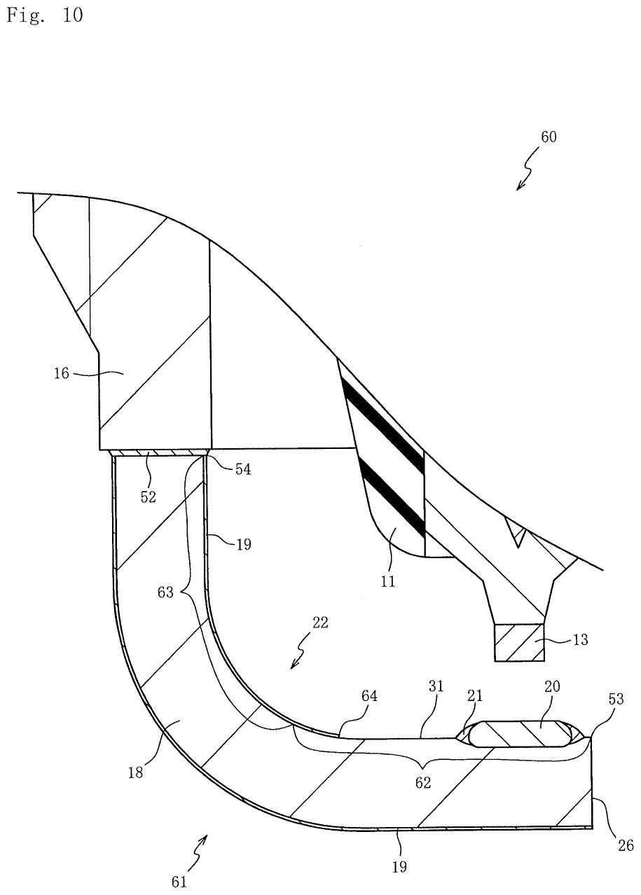

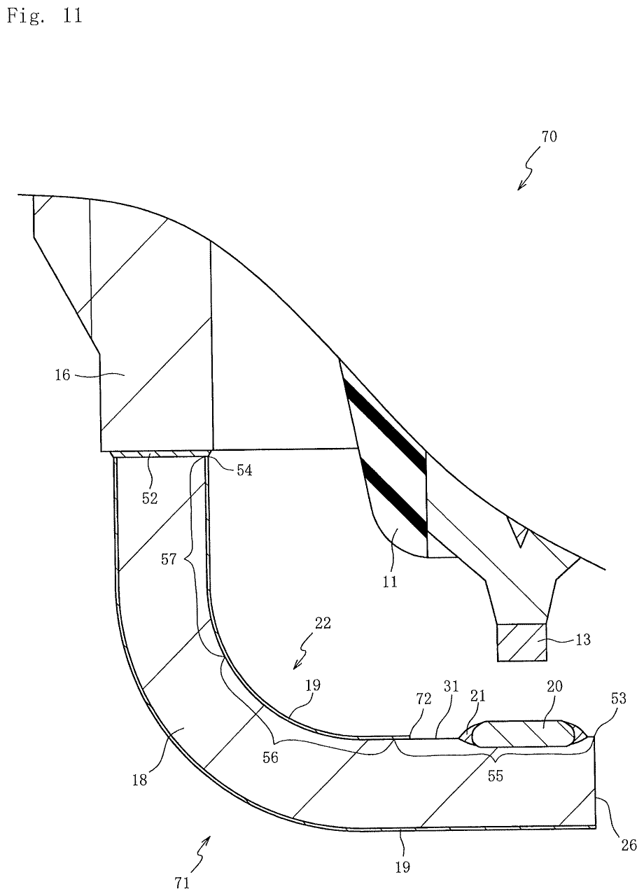

FIG. 8 is a partial sectional view of a spark plug 50 according to the third embodiment. In FIG. 8, the rear end side of each of an insulator 11, a center electrode 13, and a metal shell 16 is omitted (the same applies to FIGS. 10 and 11). A ground electrode 51 of the spark plug 50 is connected to the metal shell 16 by a weld portion 52. The ground electrode 51 includes the uneven surface 31 only in the opposed surface 22. In each of a reverse surface 23 (refer to FIG. 3) and side surfaces 24 and 25 of the ground electrode 51, a metal film 19 covers a base material 18 entirely.

When a creepage distance of the opposed surface 22 of the ground electrode 51 (the length of the opposed surface 22 in the longitudinal direction) between a corner 53 at which the opposed surface 22 intersects a distal end surface 26 and an end 54 of the weld portion 52 is trisected, and the opposed surface 22 is divided into a first portion 55, a second portion 56, and a third portion 57 in this order from the corner 53 toward the end 54, a chip 20 is provided on the first portion 55. The first portion 55, the second portion 56, and the third portion 57 each include the uneven surface 31. A boundary 58 of the uneven surface 31 exists on the third portion 57. In the present embodiment, the metal film 19 is provided, on the third portion 57, side by side with the uneven surface 31 and is in contact with the boundary 58 of the uneven surface 31 and with the end 54.

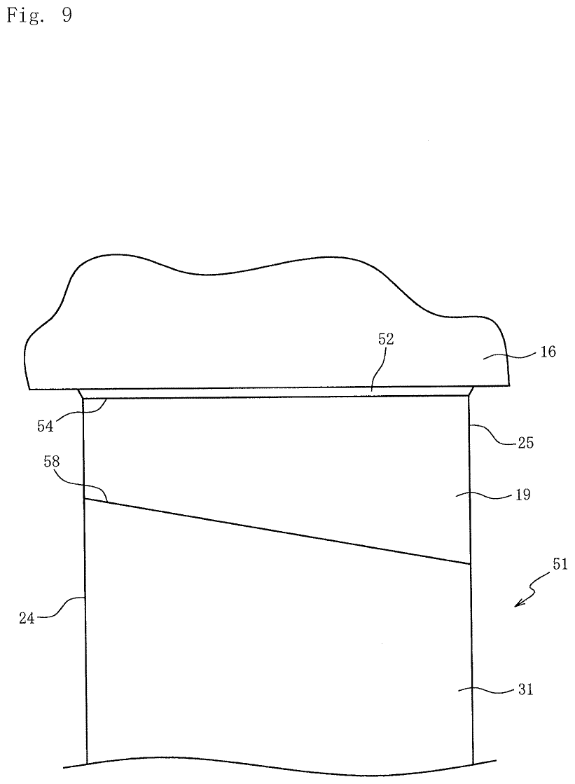

FIG. 9 is a front view of the ground electrode 51 when viewed in a direction of arrow IX in FIG. 8. In FIG. 9, illustration of the distal end side of the ground electrode 51 is omitted, and a portion of the metal shell 16 is illustrated. In the boundary 58 of the uneven surface 31, an end closer to the side surface 24 is positioned closer to the weld portion 52 than an end closer to the side surface 25. The expression “the boundary 58 of the uneven surface 31 exists on the third portion 57 (refer to FIG. 8)” means that a portion, in the boundary 58 of the uneven surface 31, positioned closest to the weld portion 52 exists on the third portion 57.

Description here will be made with reference again to FIG. 8. Since the first portion 55, the second portion 56, and the third portion 57 of the opposed surface 22 include the uneven surface 31, when a starting point of discharge of the ground electrode 51 is moved from the chip 20 to the vicinity of the chip 20 due to a flow in the combustion chamber, such a starting point of discharge is easily formed on the uneven surface 31. Thus, discharge can be easily maintained.

Since the boundary 58 of the uneven surface 31 exists on the third portion 57, compared with the case where the uneven surface 31 is provided up to the end 54 of the weld portion 52, the length from the corner 53 of the opposed surface 22 to the boundary 58 of the uneven surface 31 can be shortened. Thus, the bending stress that acts on the boundary 58 due to the load applied to the ground electrode 51 by ignition and combustion of fuel can be reduced, and the service life of the ground electrode 51 can thereby be improved.

Since the metal film 19 exists on the third portion 57 of the opposed surface 22, compared with the case where no metal film 19 exists on the opposed surface 22, the first portion 55 is easily cooled due to the heat conduction of the base material 18 and the metal film 19. Overheating of the chip 20 can be reduced, and the wear resistance of the chip 20 can thereby be improved.

Since the ground electrode 51 includes the uneven surface 31 only in the opposed surface 22, compared with the case where the reverse surface 23 and the side surfaces 24 and 25 of the ground electrode 51 also include the uneven surface 31, the sectional area of the ground electrode 51 can be increased. The bending stress of the ground electrode 51 can be reduced, and the service life of the ground electrode 51 can thereby be improved.

FIG. 10 is a partial sectional view of a spark plug 60 according to the fourth embodiment. In the fourth embodiment, the same parts as those described in the first embodiment, the second embodiment, or the third embodiment are denoted by the same reference signs, and the description thereof will hereinafter be omitted.

A ground electrode 61 of the spark plug 60 includes the uneven surface 31 only in the opposed surface 22. In each of a reverse surface 23 (refer to FIG. 3) and side surfaces 24 and 25 of the ground electrode 61, a metal film 19 covers a base material 18 entirely. When a creepage distance of the opposed surface 22 of the ground electrode 61 (the length of the opposed surface 22 in the longitudinal direction) between a corner 53 of the opposed surface 22 and an end 54 of a weld portion 52 is bisected, and the opposed surface 22 is divided into a fourth portion 62 and a fifth portion 63 in this order from the corner 53 toward the end 54, the fourth portion 62 is provided with a chip 20 and includes the uneven surface 31. A boundary 64 of the uneven surface 31 exists on the fourth portion 62. In the present embodiment, the metal film 19 is provided, on the fourth portion 62 and the fifth portion 63, side by side with the uneven surface 31 and is in contact with the boundary 64 of the uneven surface 31 and with the end 54.

Since the fourth portion 62 of the opposed surface 22 includes the uneven surface 31, when a starting point of discharge of the ground electrode 61 is moved from the chip 20 to the vicinity of the chip 20 due to a flow in the combustion chamber, such a starting point of discharge is easily formed on the uneven surface 31. Thus, discharge can be easily maintained.

Since the boundary 64 of the uneven surface 31 exists on the fourth portion 62, compared with the case where the boundary 64 exists on the fifth portion 63, the bending stress that acts on the boundary 64 due to the load applied to the ground electrode 61 by ignition and combustion of fuel can be reduced. Thus, the service life of the ground electrode 61 can be improved.

Since the metal film 19 exists on the fourth portion 62 and the fifth portion 63 of the opposed surface 22, compared with the case where no metal film 19 exists on the opposed surface 22, the fourth portion 62 is easily cooled due to the heat conduction of the base material 18 and the metal film 19. Overheating of the chip 20 can be reduced, and the wear resistance of the chip 20 can thereby be improved.

FIG. 11 is a partial sectional view of a spark plug 70 according to the fifth embodiment. In the fifth embodiment, the same parts as those described in the first embodiment, the second embodiment, or the third embodiment are denoted by the same reference signs, and the description thereof will hereinafter be omitted.

A ground electrode 71 of the spark plug 70 includes the uneven surface 31 only in the opposed surface 22. In each of a reverse surface 23 (refer to FIG. 3) and side surfaces 24 and 25 of the ground electrode 71, a metal film 19 covers a base material 18 entirely. A first portion 55 of the ground electrode 71 includes the uneven surface 31. A boundary 72 of the uneven surface 31 exists on the first portion 55. In the present embodiment, the metal film 19 is provided, on the first portion 55, a second portion 56, and a third portion 57, side by side with the uneven surface 31 and is in contact with the boundary 72 of the uneven surface 31 and with an end 54.

Since the first portion 55 of the opposed surface 22 includes the uneven surface 31, when a starting point of discharge of the ground electrode 71 is moved from a chip 20 to the vicinity of the chip 20 due to a flow in the combustion chamber, such a starting point of discharge is easily formed on the uneven surface 31. Thus, discharge can be easily maintained.

Since the boundary 72 of the uneven surface 31 exists on the first portion 55, compared with the case where the boundary 72 exists on the second portion 56 or the third portion 57, the bending stress that acts on the boundary 72 due to the load applied to the ground electrode 71 by ignition and combustion of fuel can be reduced. Thus, the service life of the ground electrode 71 can be improved.

Since the metal film 19 exists on the first portion 55, the second portion 56, and the third portion 57 of the opposed surface 22, compared with the case where no metal film 19 exists on the opposed surface 22, the first portion 55 is easily cooled due to the heat conduction of the base material 18 and the metal film 19. Overheating of the chip 20 can be reduced, and the wear resistance of the chip 20 can thereby be improved.

Although the present invention has so far been described with reference to the embodiments, the present invention is not limited to the above-described embodiments, and it is readily understood that various improvements and modifications may be made without departing from the spirit of the present invention.

Although the case where the chip 20 has a disk shape is described in the embodiments, this is not the only option. The chip 20 is appropriately set in a shape such as a quadrangular prism, a polygonal prism other than the quadrangular prism, or a truncated cone.

Although the case where the base material 18 of the ground electrodes 17, 40, 51 61, and 71 is a bent rod whose section has a quadrilateral shape is described in the embodiments, this is not the only option. Examples of the shape of the base material 18 include, in addition to a bent shape, a linear shape. Examples of the shape of the section of the base material 18 include, in addition to a quadrilateral, a circle, an ellipse, and a semicircle.

Although the case where the weld portion 21 is provided between the outer periphery of the chip 20 and the base material 18, and a bottom surface of the chip 20 and the base material 18 are in contact with each other is described in the embodiments, this is not the only option. The weld portion 21 may be provided from the outer periphery to the bottom surface of the chip 20 by laser beam welding. In addition, when the weld portion 21 is formed by resistance welding, the weld portion 21 can be provided between the bottom surface of the chip 20 and the base material 18.

Although the case where the uneven portions 32 extend in the longitudinal direction of each of the ground electrodes 17, 51, 61, and 71 is described in the embodiments, this is not the only option. The first direction where the uneven portions 32 extend may be the transverse direction of each of the ground electrodes 17, 51, 61, and 71. The expression “the uneven portions 32 extend in the transverse direction of each of the ground electrodes 17, 51, 61, and 71” means that the angle of each of the uneven portions 32 relative to a perpendicular drawn perpendicularly to an edge, of the opposed surface 22, extending in the longitudinal direction of each of the ground electrodes 17, 51, 61, and 71 is less than 45°. The flow moving in the longitudinal direction of each of the ground electrodes 17, 51, 61, and 71 tends to be slower in flow velocity than the flow moving in the transverse direction of each of the ground electrodes 17, 51, 61, and 71 but can facilitate maintenance of discharge because, when a starting point of discharge is moved from the chip 20 to the vicinity of the chip 20 due to the flow, such a starting point of discharge is easily formed on the uneven portions 32, and discharge can thereby be easily maintained.

Although the case where, in each of the ground electrodes 17, 40, and 51, a corresponding type of the uneven portions 32 and the uneven portions 42 is provided entirely in the opposed surface 22 except in the spots at which the chip 20 and the weld portion 21 are disposed is described in the first to third embodiments, this is not the only option. The uneven surface 31 and/or the uneven surface 41 may be provided only in the second end portion 29, in the opposed surface 22, or may be provided only in a portion of the opposed surface 22 from the second end portion 29 to the bent portion 30 (a portion except for the first end portion 28). The metal film 19 may be provided on a portion of the opposed surface 22 other than the uneven surfaces 31 and 41. In this case, the uneven surface 31 and/or the uneven surface 41 may be adjacent to the metal film 19, or a part not including the uneven portion 32 or 42 may be provided between the uneven surface 31 and/or the uneven surface 41 and the metal film 19.

Although the case where the metal film 19 is provided on the reverse surface 23 and the side surfaces 24 and 25 of each of the ground electrodes 17, 51, 61, and 71 is described in the first embodiment, the third embodiment, the fourth embodiment, and the fifth embodiment, this is not the only option. For example, the metal film 19 of the reverse surface 23 and the side surfaces 24 and 25 may be entirely omitted, the metal film 19 of the reverse surface 23 may be omitted, or the metal film 19 of any one or both of the side surfaces 24 and 25 may be omitted. That is, at least a portion of the metal film 19 of each of the ground electrodes 17, 51, 61, and 71 may be omitted.

Although the case where the metal film 19 is provided on the reverse surface 23 but not on the side surface 24 or 25 of the ground electrode 40 is described in the second embodiment, this is not the only option. The metal film 19 of the reverse surface 23 may be omitted, or the metal film 19 may be provided on any one or both of the side surfaces 24 and 25.

Although the case where the uneven portions 42 are provided entirely in the side surfaces 24 and 25 of the ground electrode 40 is described in the second embodiment, this is not the only option. Instead of the uneven portions 42, the uneven portions 32 may be provided entirely in the side surfaces 24 and 25. In addition, the uneven surface 31 and/or the uneven surface 41 may be provided in the side surface 24, and the metal film 19 may be provided on the side surface 25. Alternatively, the metal film 19 may be provided on the side surface 24, and the uneven surface 31 and/or the uneven surface 41 may be provided in the side surface 25. When the uneven surface 31 and/or the uneven surface 41 is provided in any one of the side surface 24 and the side surface 25, only the second end portion 29, in a corresponding one of the side surfaces 24 and 25, may be the uneven surface 31 and/or the uneven surface 41, or only a portion, of a corresponding one of the side surfaces 24 and 25, from the second end portion 29 to the bent portion 30 may be the uneven surface 31 and/or the uneven surface 41. The metal film 19 may be provided on a portion of the side surfaces 24 and 25 other than the uneven surfaces 31 and 41. In this case, the uneven surface 31 and/or the uneven surface 41 may be adjacent to the metal film 19, or a part not including the uneven portion 32 or 42 may be provided between the uneven surface 31 and/or the uneven surface 41 and the metal film 19.

Although the case where the uneven surface 31 is provided in the opposed surface 22 is described in the third embodiment, the fourth embodiment, and the fifth embodiment, this is not the only option. The uneven surface 41 may be provided in the opposed surface 22 in the third embodiment, the fourth embodiment, and the fifth embodiment.

Although the case where the metal film 19 is adjacent to the uneven surface 31 provided in the opposed surface 22 is described in the third embodiment, the fourth embodiment, and the fifth embodiment, this is not the only option. The uneven surface 31 and/or the uneven surface 41 may be provided in the opposed surface 22 after the metal film 19 is removed by using, for example, a peeling solution. Thus, the metal film 19 of the opposed surface 22 can be removed, or a part not including the uneven portion 32 or 42 can be provided between the uneven surface 31 and/or the uneven surface 41 of the opposed surface 22 and the metal film 19.

### DESCRIPTION OF REFERENCE NUMERALS

10, 50, 60, 70 spark plug
13 center electrode
14 tip end surface
16 metal shell
17, 40, 51, 61, 71 ground electrode
18 base material
19 metal film
20 chip
21, 52 weld portion
22 opposed surface
23 reverse surface
24, 25 side surfaces
26 distal end surface
27 end surface
28 first end portion
29 second end portion
30 bent portion
31,41 uneven surface
32,42 uneven portion
33 recessed portion
34 protruding portion
53 corner
54 end
55 first portion
56 second portion
57 third portion
58,64,72 boundary
62 fourth portion
63 fifth portion
D1 first direction
D2 second direction
H distance (maximum height)

What is claimed is:

1. A spark plug comprising:
a metal shell;
a center electrode held by the metal shell in an insulated manner;
a ground electrode including a first end portion and a second end portion, the ground electrode being connected to the metal shell at the first end portion and extending to the second end portion; and
a chip disposed on an opposed surface, in the ground electrode, opposite to a tip end surface of the center electrode, wherein
the opposed surface includes an uneven surface including an uneven portion extending in a first direction, and,
in the uneven surface, a maximum height that is a distance between a highest portion and a lowest portion is 3 μm or more.

2. The spark plug according to claim 1, wherein
the first direction is a longitudinal direction of the ground electrode.

3. The spark plug according to claim 1, wherein
the uneven surface also includes an uneven portion extending in a second direction intersecting the first direction.

4. The spark plug according to claim 1, wherein
the ground electrode includes a base material and a metal film covering the base material,
a thermal conductivity of the metal film is higher than a thermal conductivity of the base material, and
the uneven surface is provided in a portion, of the base material, not being covered with the metal film.

5. The spark plug according to claim 1, wherein
the maximum height is 53 μm or less.

6. The spark plug according to claim 1, wherein,
when a length of the opposed surface in a longitudinal direction of the opposed surface is trisected, and the opposed surface is divided into a first portion, a second portion, and a third portion in this order from the second end portion toward the first end portion of the ground electrode,
the first portion, the second portion, and the third portion include the uneven surface, and
a boundary of the uneven surface exists on the third portion.

7. The spark plug according to claim 1, wherein,
when a length of the opposed surface in a longitudinal direction of the opposed surface is bisected, and the opposed surface is divided into a fourth portion and a fifth portion in this order from the second end portion toward the first end portion of the ground electrode,
the fourth portion includes the uneven surface, and
a boundary of the uneven surface exists on the fourth portion.

8. The spark plug according to claim 1, wherein,
when a length of the opposed surface in a longitudinal direction of the opposed surface is trisected, and the opposed surface is divided into a first portion, a second portion, and a third portion in this order from the second end portion toward the first end portion of the ground electrode,
the first portion includes the uneven surface, and
a boundary of the uneven surface exists on the first portion.

9. The spark plug according to claim 1, wherein
the uneven surface is provided only in the opposed surface.

10. The spark plug according to claim 1, wherein
the uneven surface includes a range in which five or more recessed portions exist, and protruding portions not intersecting one another exist.
